(19) United States
(12) Patent Application Publication
(10) Pub. No.: US 2019/0232794 A1
(43) Pub. Date: Aug. 1, 2019

(54) PORTABLE ELECTRIC VEHICLE CHARGER

(71) Applicant: Michael SPARKS, Newhall, CA (US)

(72) Inventor: Michael SPARKS, Newhall, CA (US)

(21) Appl. No.: 15/885,283

(22) Filed: Jan. 31, 2018

(51) Int. Cl. B60L 11/18; H02H 7/20

(52) U.S. Cl. CPC B60L 11/1818; H02H 7/20

(57) ABSTRACT

Embodiments of the present invention may provide charging apparatus that provides high-capacity charging of electric vehicles, yet is portable and does not have to be installed by an electrician. In an embodiment of the present invention, an apparatus may comprise a portable enclosure, at least one power input receptacle mounted to the portable enclosure, at least one first circuit breaker electrically connected to the power input receptacle, at least one power outlet electrically connected to the at least one first circuit breaker, at least one second circuit breaker electrically connected to the power input receptacle, and at least one electric vehicle charger connected to the at least one second circuit breaker.

### BACKGROUND

The present invention relates to a portable apparatus for high-capacity charging of batteries of electric vehicles.

Among trends in transportation, electric vehicles, and in particular, electric automobiles, have become a recent wave product. Available electric vehicles, and sales of such vehicles, are increasing rapidly. However, infrastructure issues remain to be resolved before universal adoption of electric vehicles becomes a reality. In particular, electric vehicles require charging of their batteries at fairly regular mileage intervals. Public charging stations have become fairly common, but issues remain with at-home charging of electric vehicles.

Two main types of home charging solutions are currently available. Low-capacity chargers that are relatively low in cost, and may be plugged in to a standard 120V outlet. However, such chargers provide a low charge rate and so charge electric vehicles very slowly. At best, low-rate charging is very time consuming, but in many cases, low-rate charging may not provide sufficient charge capacity for long term operation of a vehicle. For example, under many usage patterns, low-capacity chargers may not fully recharge the batteries of an electric vehicle, even overnight. High-capacity charging stations provide much greater charge rates, reducing the time consumed and handling more demanding usage scenarios. However, such charging stations must currently be installed by an electrician in a fixed location. This means that the cost of installation is high, while the flexibility of such charging stations is limited. While this may be suitable for public charging stations, this is a disadvantage for home use of high-capacity charging stations.

Accordingly, a need arises for a charging apparatus that provides high-capacity charging of electric vehicles, yet is portable and does not have to be installed by an electrician.

### SUMMARY

Embodiments of the present invention may provide a charging apparatus that provides high-capacity charging of electric vehicles, yet is portable and does not have to be installed by an electrician.

In an embodiment of the present invention, an apparatus may comprise a portable enclosure, at least one power input receptacle mounted to the portable enclosure, at least one first circuit breaker electrically connected to the power input receptacle, at least one power outlet electrically connected to the at least one first circuit breaker, at least one second circuit breaker electrically connected to the power input receptacle, and at least one electric vehicle charger connected to the at least one second circuit breaker.

In some embodiments, the portable enclosure may comprise a case mounted to a frame. The frame may have wheels attached thereto. The at least one power input receptacle may be adapted for connection to 240V power. The at least one first circuit breaker may be adapted for connection to 240V power. The apparatus may further comprise at least one redundant circuit breaker electrically connected to the at least one first circuit breaker. The at least one power outlet may be electrically connected to the at least one redundant circuit breaker, and the at least one redundant circuit breaker and the at least one power outlet are adapted for connection to a 240V power and/or a 120V power. The apparatus may further comprise at least one ground fault circuit interrupter circuit breaker electrically connected to the at least one first circuit breaker. The at least one power outlet may be electrically connected to the at least one ground fault circuit interrupter circuit breaker, and the at least one ground fault circuit interrupter circuit breaker and the at least one power outlet are adapted for connection to 120V power. The electric vehicle charger may be a TESLA® charger.

In an embodiment, a method for charging an electric vehicle may comprise providing an apparatus comprising a portable enclosure, at least one power input receptacle mounted to the portable enclosure, at least one first circuit breaker electrically connected to the power input receptacle, at least one power outlet electrically connected to the at least one first circuit breaker, at least one second circuit breaker electrically connected to the power input receptacle, and at least one electric vehicle charger connected to the at least one second circuit breaker, connecting the apparatus to an existing power connection using the at least one power input receptacle, and charging the electric vehicle using the at least one electric vehicle charger.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of a charging apparatus in which techniques of the present invention may be implemented.

FIG. 2 is exemplary block diagram of the charging apparatus shown in FIG. 1.

FIG. 3 is an exemplary illustration of Camlock connectors—plugs and receptacles.

FIG. 4 is an exemplary illustration of standard National Electrical Manufacturers Association (NEMA) power connectors.

FIG. 5 is an exemplary illustration of an electric vehicle charger.

### DETAILED DESCRIPTION

Embodiments of the present invention may provide a charging apparatus that provides high-capacity charging of electric vehicles, yet is portable and does not have to be installed by an electrician.

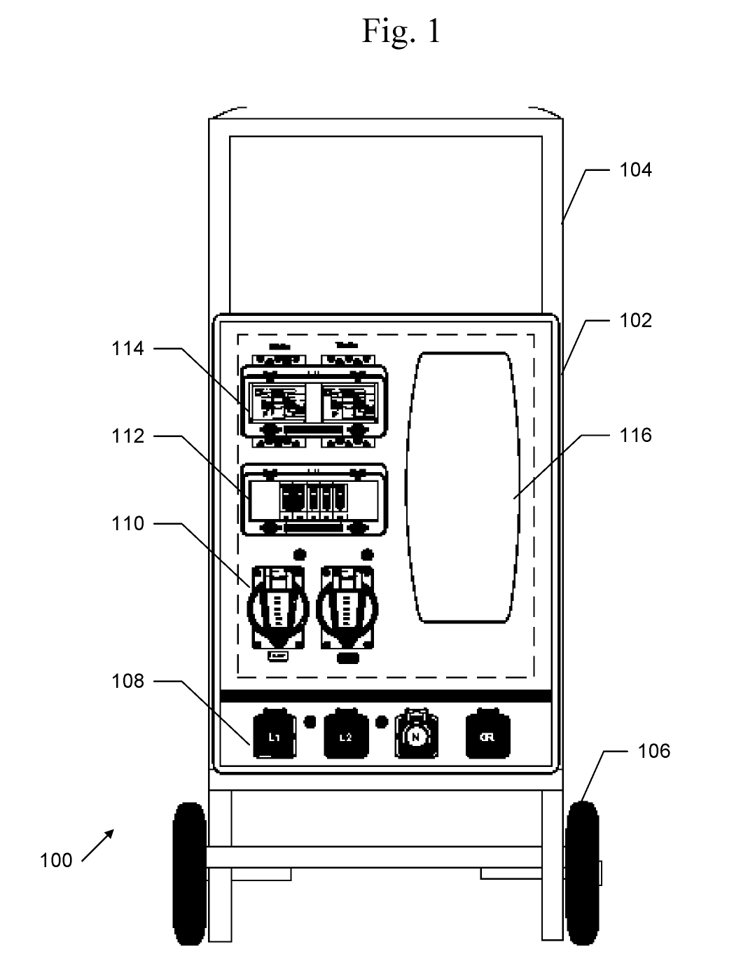

An example of a charging apparatus 100 in which techniques of the present invention may be implemented is shown in FIG. 1. In this example, a high-capacity, portable charger is shown. Apparatus 100 may include a case 102, a frame or dolly 104, wheels 106, a plurality of power connectors 108, 110, circuit breakers 112, 114, and EV charger 116. Case 102 may be constructed from any suitably strong and sturdy material and sized so as to hold all of the included components. For example, case 102 may be constructed from a water-resistant plastic suitable for use both indoors and outdoors. Frame 104 may be constructed from any suitably strong and sturdy material and sized so as to hold case 102. For example, frame 104 may be constructed of steel or aluminum, and may be a pre-existing or custom-made dolly, including wheels 106. The use of a dolly for frame 104 provides portability for apparatus 100.

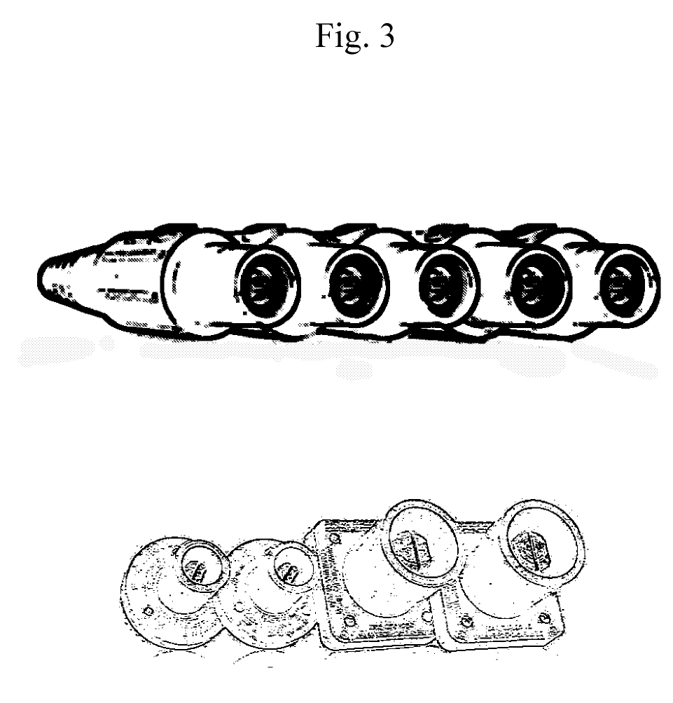

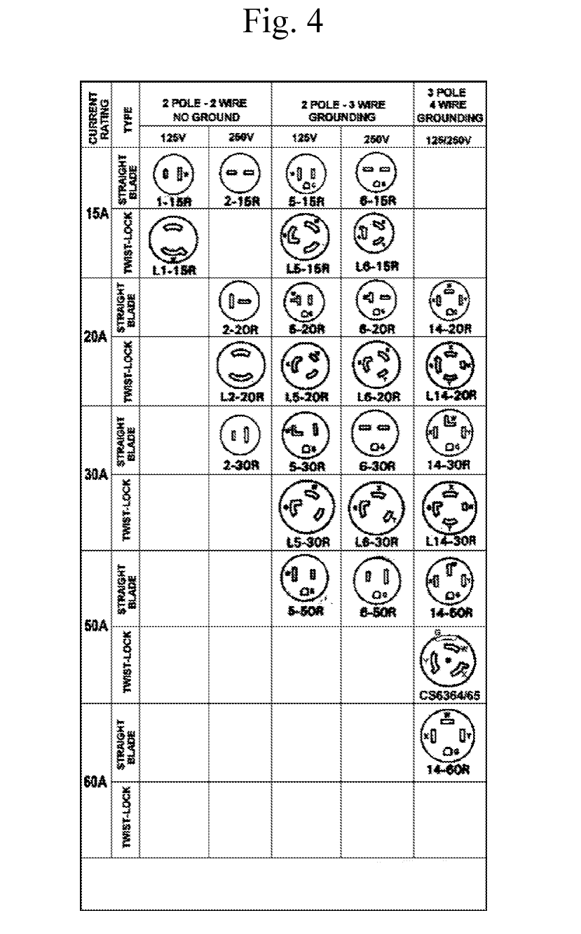

Apparatus 100 may provide a plurality of power connectors 108, 110. For example, power connectors 108 may be Camlock power connectors, such as those made by Cooper Industries, such as those shown in FIG. 3. Examples may include the Cooper Industries for example, the E1015, E1016, E1017, EZ1016, E1018 series, etc. Power connectors 110 may include standard National Electrical Manufacturers Association (NEMA) power connectors, such as those shown in FIG. 4. Typically, power connectors 108 may be used to provide power input to apparatus 100, while power connectors 110 may be used to provide power output from apparatus 100. For example, NEMA 14-50R may be used to provide 240V power at up to 50 A. Power connectors 108 may provide connection to 240V, high amperage circuits, while power connectors 110 may provide 120V or 240V high or medium amperage circuits to equipment in the vicinity of apparatus 100. These listed power connectors are merely examples. Any type, configuration, or brand of power connector, or combination of power connectors, that may provide the desired voltage and current capacity may be used.

Apparatus 100 may provide a plurality of circuit breakers 112, 114 to protect against short-circuits and overloads. For example, circuit breakers 114 may provide protection for 240V high amperage circuits, while circuit breakers 112 may provide protection for 120V or 240V medium amperage circuits.

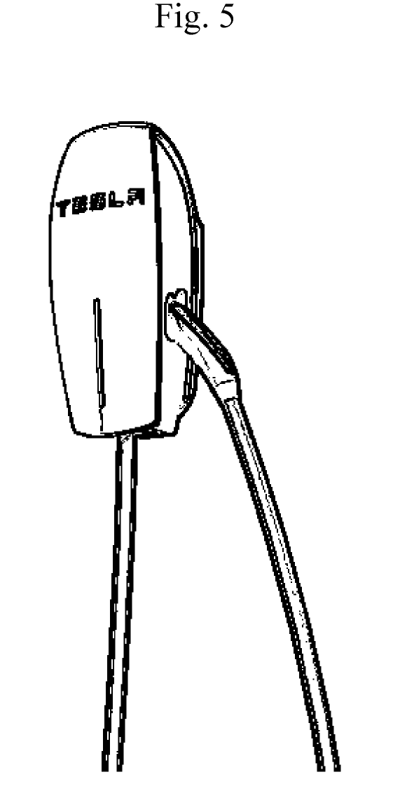

EV charger 116 is typically a proprietary charger provided by the manufacturer of the electric vehicle. For example, for charging TESLA® vehicles, a TESLA® Wall Connector, such as that shown in FIG. 5, may be included in apparatus 100.

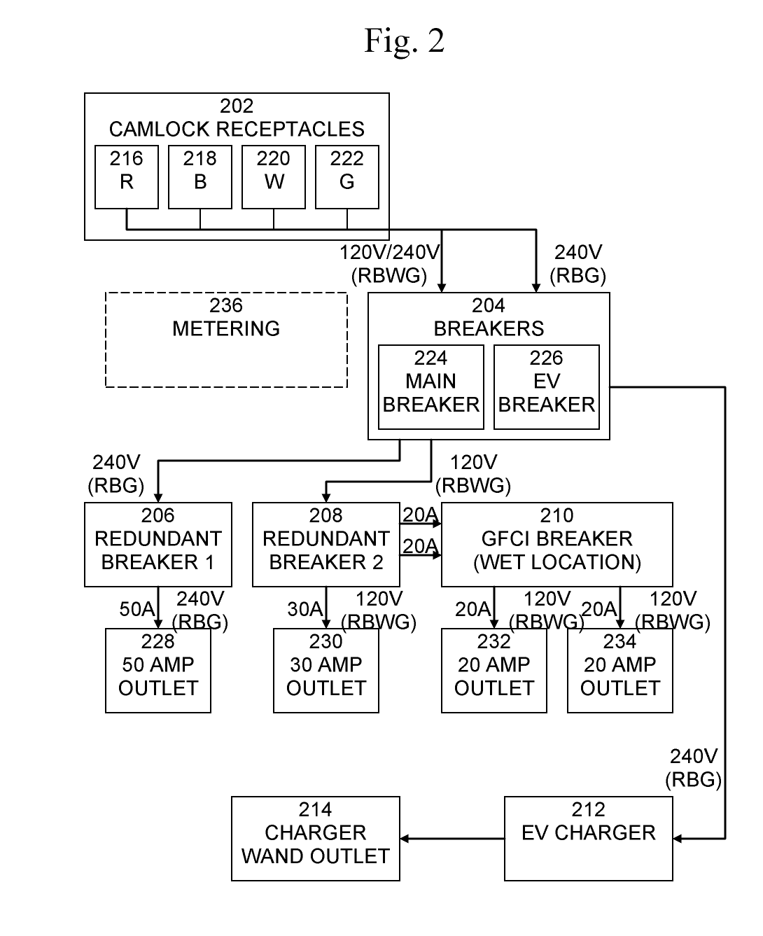

Turning now to FIG. 2, an exemplary block diagram of circuitry included in apparatus 100 is shown. As shown, apparatus 100 may include power input connectors, such as Camlock receptacles 202, circuit breakers 204, redundant circuit breakers 206, 208, ground fault circuit interrupter (GFCI) breaker 210, EV charger 212, and EV charger wand outlet 214. Camlock receptacles 202 may include a receptacle for each circuit included in 240V single-phase power, or in two lines of 120V single-phase power. For example, Camlock receptacles 202 may include receptacles for the live lines, red (R) 216 and blue (B) 218, neutral, white (W) 220, and ground, green (G) 222. The use of power input connectors provides the capability to easily and quickly connect and disconnect apparatus 100 from existing electrical circuits in various locations. Camlock connectors provide a convenient means for such connections, but any other type of electrical connector having suitable current and voltage specifications may be used. Typically the ground, green (G) 222, is also connected to the case and the frame, providing user protection from short circuits or shocks.

The power from receptacles 202 is fed to circuit breakers 204, which may include a main circuit breaker 224 and an EV charger circuit breaker 226. For example, all four lines, including live lines, red (R) 216 and blue (B) 218, neutral, white (W) 220, and ground, green (G) 222 may be fed to main circuit breaker 224 to provide two circuits of split-phase 120V power and/or 240V power. The necessary 240V lines, live lines, red (R) 216 and blue (B) 218, and ground, green (G) 222 may be fed to EV charger circuit breaker 226 to provide 240V power. Breakers 204 provide overload and short-circuit protection for their associated circuits.

Power from main circuit breaker 224 is fed to first redundant circuit breaker 206 and second redundant circuit breaker 208. For example, the necessary 240V lines, live lines, red (R) 216 and blue (B) 218, and ground, green (G) 222 may be fed to first redundant circuit breaker 206 to provide 240V power. First redundant circuit breaker 206 may provide a current capacity of 50 A, and may include a single 50 A circuit breaker, or may include two 25 A circuit breakers. Likewise, all four lines, including live lines, red (R) 216 and blue (B) 218, neutral, white (W) 220, and ground, green (G) 222 may be fed to second redundant circuit breaker 208 to provide two circuits of split-phase 120V power. Power from first redundant circuit breaker 206 is fed to one or more outlets, such as 50 A outlet 228. For example, the necessary 240V lines, live lines, red (R) 216 and blue (B) 218, and ground, green (G) 222 may be fed to 50 A outlet 228 to provide 240V power. Power from second redundant circuit breaker 208 may be fed to one or more outlets, such as 30 A outlet 230. For example, all four lines, including live lines, red (R) 216 and blue (B) 218, neutral, white (W) 220, and ground, green (G) 222 may be fed to 30 A outlet 230 to provide two circuits of split-phase 120V power. Likewise, power may be fed from second redundant circuit breaker 208 to GFCI circuit breaker 210. GFCI circuit breaker 210 quickly and automatically disconnects a circuit when it detects that the electric current is not balanced between the live lines and the neutral lines and provides protection from shocks due to contact with the live lines. This allows electrical devices to be used in otherwise potentially unsafe conditions, such as wet locations. For example, power may be fed from GFCI circuit breaker 210 to one or more 20A outlets 232, 234. For example, all four lines, including live lines, red (R) 216 and blue (B) 218, neutral, white (W) 220, and ground, green (G) 222 may be fed to 30 A outlet 230 to provide two circuits of GFCI protected split-phase 120V power. Alternatively, or in addition, GFCI outlets may be connected to first redundant circuit breaker 206 or second redundant circuit breaker 208, providing GFCI protection at the outlet, rather than at the circuit breaker.

Power from EV circuit breaker 226 is fed to EV charger 212. For example, the necessary 240V lines, live lines, red (R) 216 and blue (B) 218, and ground, green (G) 222 may be fed to EV charger 212 to provide 240V power for charging an electric vehicle. Typically, EV charger 212 includes a charger wand, cable, or other connection, which may plug in to charger wand outlet 214. The charger wand, cable, or other connection also connects to the charging port of an electric vehicle and supplies the charging current to the vehicle.

Also shown in FIG. 2 is optional metering circuitry 236. Metering circuitry 236 may measure instantaneous parameters, such as voltage, current, and power, or metering circuitry 236 may measure aggregate parameters, such as average voltage, current, and power, or energy usage.

The specific connectors and circuit breakers described herein are merely examples. Any other type of electrical connector having suitable current and voltage specifications may be used. Likewise, any type of circuit breaker having current and voltage specifications meeting the desired capacity of apparatus 100 may be used. Likewise, the specific configurations of components shown in FIGS. 1 and 2 are merely examples. Any other configuration of components providing the desired functionality may be used. Further, FIG. 2 shows examples of electrical connection of components. Such electrical connection may include direct connection between components, with no other components electrically connected between the components, or indirect connection between components, with one or more other components electrically connected between the components,

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An apparatus comprising:
a portable enclosure;
at least one power input receptacle mounted to the portable enclosure;
at least one first circuit breaker electrically connected to the power input receptacle;
at least one power outlet electrically connected to the at least one first circuit breaker;
at least one second circuit breaker electrically connected to the power input receptacle; and
at least one electric vehicle charger connected to the at least one second circuit breaker.

2. The apparatus of claim 1, wherein the portable enclosure comprises a case mounted to a frame.

3. The apparatus of claim 2, wherein the frame has wheels attached thereto.

4. The apparatus of claim 1, wherein the at least one power input receptacle is adapted for connection to 240V power.

5. The apparatus of claim 4, wherein the at least one first circuit breaker is adapted for connection to 240V power.

6. The apparatus of claim 5, further comprising at least one redundant circuit breaker electrically connected to the at least one first circuit breaker.

7. The apparatus of claim 6, wherein the at least one power outlet is electrically connected to the at least one redundant circuit breaker and the at least one redundant circuit breaker and the at least one power outlet are adapted for connection to 240V power.

8. The apparatus of claim 7, wherein the at least one power outlet is electrically connected to the at least one redundant circuit breaker and the at least one redundant circuit breaker and the at least one power outlet are adapted for connection to 120V power.

9. The apparatus of claim 5, further comprising at least one ground fault circuit interrupter circuit breaker electrically connected to the at least one first circuit breaker.

10. The apparatus of claim 9, wherein the at least one power outlet is electrically connected to the at least one ground fault circuit interrupter circuit breaker and the at least one ground fault circuit interrupter circuit breaker and the at least one power outlet are adapted for connection to 120V power.

11. The apparatus of claim 1, wherein the electric vehicle charger is a TESLA® charger.

12. A method for charging an electric vehicle comprising:
providing an apparatus comprising a portable enclosure, at least one power input receptacle mounted to the portable enclosure, at least one first circuit breaker electrically connected to the power input receptacle, at least one power outlet electrically connected to the at least one first circuit breaker, at least one second circuit breaker electrically connected to the power input receptacle, and at least one electric vehicle charger connected to the at least one second circuit breaker;
connecting the apparatus to an existing power connection using the at least one power input receptacle mounted; and
charging the electric vehicle using the at least one electric vehicle charger.

13. The method of claim 12, wherein the portable enclosure comprises a case mounted to a frame having wheels attached thereto.

14. The method of claim 12, wherein the at least one power input receptacle is adapted for connection to 240V power and the at least one first circuit breaker is adapted for connection to 240V power.

15. The method of claim 14, further comprising at least one redundant circuit breaker electrically connected to the at least one first circuit breaker.

16. The method of claim 15, wherein the at least one power outlet is electrically connected to the at least one redundant circuit breaker and the at least one redundant circuit breaker and the at least one power outlet are adapted for connection to 240V power.

17. The method of claim 16, wherein the at least one power outlet is electrically connected to the at least one redundant circuit breaker and the at least one redundant circuit breaker and the at least one power outlet are adapted for connection to 120V power.

18. The method of claim 14, further comprising at least one ground fault circuit interrupter circuit breaker electrically connected to the at least one first circuit breaker.

19. The method of claim 9, wherein the at least one power outlet is electrically connected to the at least one ground fault circuit interrupter circuit breaker and the at least one ground fault circuit interrupter circuit breaker and the at least one power outlet are adapted for connection to 120V power.

20. The method of claim 12, wherein the electric vehicle charger is a TESLA® charger.
